(19) United States
(12) Patent Application Publication
(10) Pub. No.: US 2020/0093190 A1
(43) Pub. Date: Mar. 26, 2020

(54) Disposable Sticky Bib

(71) Applicant: Beijing Dachen Trade Co., Ltd., Beijing (CN)

(72) Inventor: Xin Jiang, Beijing (CN)

(21) Appl. No.: 16/181,760

(22) Filed: Nov. 6, 2018

(30) Foreign Application Priority Data
Sep. 26, 2018 (CN) 201821576546.1

(51) Int. Cl. A41B 13/10; B32B 7/06; B32B 7/12; B32B 5/02; B32B 27/12; B32B 27/32; B32B 27/20

(52) U.S. Cl. CPC A41B 13/10; B32B 2555/00; B32B 7/12; B32B 5/022; B32B 27/12; B32B 27/32; B32B 27/20; A41B 2400/34; A41B 2400/36; A41B 2400/62; A41B 2400/52; A41B 2300/328; B32B 2307/7265; B32B 2307/758; B32B 2262/062; B32B 7/06

(57) ABSTRACT

The present application relates to the technical field of baby accessories and discloses a disposable sticky bib. The disposable sticky bib comprises a sticky bib main body and a sticky tongue, wherein the sticky bib main body is provided with a waterproof layer, a water-absorbing layer and a permeable layer, the water-absorbing layer is arranged between the permeable layer and the waterproof layer, and a sticking layer and a first anti-sticking layer capable of covering the sticking layer are arranged on the inner side face of the waterproof layer; and the shape of the upper edge of the sticky bib main body is consistent with the shape of the upper edge of a front collar, and the sticky tongue can be bent and stuck on the inner side of the front collar.

### CROSS REFERENCE TO RELATED APPLICATION

This application claims priority to and takes the benefit of Chinese Patent Application 201821576546.1 filed on Sep. 26, 2018, the contents of which are herein incorporated by reference.

### TECHNICAL FIELD

The present application relates to the technical field of baby accessories, specifically to a disposable sticky bib.

### BACKGROUND OF THE INVENTION

Bib is an essential item for babies in their growth process and is usually tied around their necks to protect their clothes from getting dirty. The traditional bib is generally made of cloth, silica gel, plastic and the like and has poor water-absorbing capacity, so, even if it can prevent saliva and food residues from contaminating the clothes, it cannot keep the chin and the face of baby dry; additionally, the traditional bib generally designs laces which can choke the baby; and the traditional bib is fixed only by using the laces so that it cannot completely fit the clothes and the saliva of baby or the food residues are easy to fall on the clothes along with spaces between the bib and the clothes, so, the traditional bib cannot keep the clothes clean.

Therefore, it is an important problem required to be solved by persons skilled in the art that the traditional bib cannot keep the chin and the face of baby dry due to its poor water-absorbing capacity, can be hazardous if the baby is choked by its laces and cannot achieve an effect of keeping the clothes clean because it cannot completely fit the clothes.

### SUMMARY OF THE INVENTION

In order to at least overcome the problem in the prior art to a certain extent, an objective of the present application is to provide a disposable sticky bib, which solves the problem that the traditional disposable sticky bib cannot keep the chin and the face of baby dry due to its poor water-absorbing capacity, can be hazardous if the baby is choked by its laces and cannot achieve an effect of keeping the clothes clean because it cannot completely fit the clothes.

The present application provides a disposable sticky bib, which comprises a sticky bib main body and a sticky tongue, the sticky bib main body is provided with a waterproof layer, a water-absorbing layer and a permeable layer, the water-absorbing layer is arranged between the permeable layer and the waterproof layer, and a sticking layer and a first anti-sticking layer capable of covering the sticking layer are arranged on the inner side face of the waterproof layer; and the shape of the upper edge of the sticky bib main body is consistent with the shape of the upper edge of a front collar, and the sticky tongue can be bent and stuck on the inner side of the front collar.

Preferably, an anti-microbial and deodorizing filler is arranged in the water-absorbing layer, between the permeable layer and the water-absorbing layer, or between the water-absorbing layer and the waterproof layer.

Preferably, the material of the water-absorbing layer is fluff pulp, high molecular water-absorbing resin or dust-free paper.

Preferably, the material of the permeable layer is pure cotton fabric or non-woven fabric.

Preferably, the material of the waterproof layer is a PE film.

Preferably, the edges of the permeable layer, the water-absorbing layer and the waterproof layer are fixed in a pressing manner.

Preferably, a sticking layer and a second anti-sticking layer are arranged on the inner side of the sticky tongue, the sticking layer is used for being stuck on the inner side of the front collar, and the second anti-sticking layer covers the sticking layer.

Preferably, the material of the sticking layer is glue.

Preferably, the material of the first anti-sticking layer and the material the second anti-sticking layer are release paper.

Preferably, the edges of the permeable layer, the water-absorbing layer and the waterproof layer are fixed in a sewing manner.

The technical scheme provided by embodiments of the present application can comprise the following beneficial effects:

When the disposable sticky bib is in use, firstly the first anti-sticking layer is torn off, then the sticky bib main body is stuck on the front collar to ensure that the upper edge of the sticky bib main body is level with the edge of the front collar, and the sticky tongue is bent to the inner side of the front collar and then is stuck on the inner side of the front collar in order to improve the firmness of the sticky bib fixed to the clothes and help the sticky bib to further fit the clothes. The sticky bib main body comprises the waterproof layer, the water-absorbing layer and the permeable layer, the waterproof layer fits the front collar through the sticking layer, the permeable layer is arranged on the outer side, and the water-absorbing layer is arranged between the permeable layer and the waterproof layer, so, when the saliva of baby, vegetable juice and the like drip onto the permeable layer, the water-absorbing layer absorbs the saliva of baby, the vegetable juice and the like on the permeable layer to keep the permeable layer dry in order to keep the chin or the neck of baby dry, and the waterproof layer prevents the saliva of baby, the vegetable juice and the like, which are absorbed by the water-absorbing layer, from wetting or contaminating the clothes. Such arrangement takes the place of the traditional bib and solves the problem that the traditional bib cannot keep the chin and the face of baby dry due to its poor water-absorbing capacity, can be hazardous if the baby is choked by its laces and cannot achieve an effect of keeping the clothes clean because it cannot completely fit the clothes.

It should be understood that both the foregoing general description and the following detailed description are exemplary and explanatory only and are not intended to limit the present application.

### BRIEF DESCRIPTION OF THE DRAWINGS

The accompanying drawings, which are incorporated in and constitute a part of this specification, illustrate embodiments consistent with the present application and, together with the specification, serve to explain the principles of the present application.

FIG. 1 is a structure diagram of a disposable sticky bib illustrated according to an exemplary embodiment; and

FIG. 2 is a structure diagram of a sticky bib main body illustrated according to an exemplary embodiment.

In the accompanying drawings: 1-sticky bib main body; 2-sticky tongue; 3-permeable layer; 4-water-absorbing layer; 5-waterproof layer; 6-sticking layer; and 7-first anti-sticking layer.

### DETAILED DESCRIPTION OF THE SEVERAL EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present application. Instead, they are merely examples of devices consistent with some aspects related to the present application as recited in the appended claims.

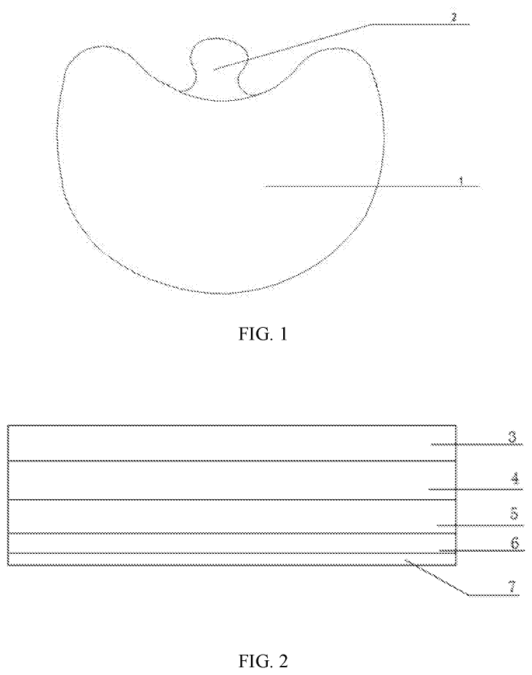

Referring to FIG. 1 and FIG. 2, the present embodiment provides a disposable sticky bib, which comprises a sticky bib main body 1 and a sticky tongue 2; the sticky bib main body 1 is provided with a waterproof layer 5, a water-absorbing layer 4 and a permeable layer 3, wherein the water-absorbing layer 4 is arranged between the permeable layer 3 and the waterproof layer 5, that is, the waterproof layer 5, the water-absorbing layer 4 and the permeable layer 3 are sequentially connected; and the waterproof layer 5 is in contact with the clothes in order to prevent the clothes from getting wet, that is, the permeable layer 3 is arranged on the outmost side, when the saliva of baby, vegetable juice and the like drip onto the permeable layer 3, the water-absorbing layer 4 absorbs the saliva of baby, the vegetable juice and the like on the permeable layer 3 to keep the permeable layer 3 dry so as to keep the chin or the neck of baby dry, and the waterproof layer 5 prevents the saliva of baby, the vegetable juice and the like, which are absorbed by the water-absorbing layer 4, from wetting or contaminating the clothes.

In order to fix the sticky bib main body 1 to the clothes, a sticking layer 6 is arranged on the inner side face of the waterproof layer 5, that is, the sticking layer 6 is arranged on one surface, in contact with the clothes, of the waterproof layer 5.

In order to prevent the stickiness of the sticking layer 6 of the sticky bib main body 1 from reducing or prevent the sticking layer 6 from being stuck on other objects, a first anti-sticking layer 7 is arranged on the sticky bib main body 1, wherein the first anti-sticking layer 7 can cover the sticking layer 6, and the disposable sticky bib may be used as long as the first anti-sticking layer 7 is torn off and the sticky bib main body 1 is stuck on the front collar.

It should be noted that the material of the sticking layer 6 can be glue, and can also be other sticky materials such as a double faced adhesive tape and the like, specifically which can be determined according to the actual requirements; and the sticking layer 6 can be configured to integrally cover the waterproof layer 5, can also be arranged at the edge of the waterproof layer 5, and can also be arranged on the two opposite sides of the waterproof layer 5 as long as the sticking layer 6 can be stuck on the front collar.

In order to prevent the clothes from getting wet or dirty, the sticky bib main body 1 can further fit the front collar, preferably the shape of the upper edge of the sticky bib main body 1 is consistent with the shape of the upper edge of the front collar in order to ensure that the upper edge of the sticky bib main body 1 is level with the edge of the front collar.

Furthermore, in order to improve the firmness of the sticky bib main body 1 stuck on the front collar, the sticky tongue 2 is arranged at the upper edge of the sticky bib main body 1, the sticky tongue 2 can be bent to the inner side of the front collar and stuck on the inner side of the front collar, and the sticky tongue 2 and the sticky bib main body 1 are provided with an integrated structure, and can also be of a separate structure, wherein the sticky tongue 2 can be bent to the inner side of the front collar; and the sticky tongue 2 and the sticky bib main body 1 can also be connected by a connector, for example, they can be sewed together and can also be connected by buttons.

When the disposable sticky bib is in use, firstly the first anti-sticking layer 7 is torn off, then the sticky bib main body 1 is stuck on the front collar to ensure that the upper edge of the sticky bib main body 1 is level with the edge of the front collar, next the sticky tongue 2 is bent to the inner side of the front collar and is stuck on the inner side of the front collar.

Such arrangement can take the place of the traditional bib and solves the problem that the traditional bib cannot keep the chin and the face of baby dry due to its poor water-absorbing capacity, can be hazardous if the baby is choked by its laces and cannot achieve an effect of keeping the clothes clean because it cannot completely fit the clothes.

In a preferable scheme of the embodiment, a filler is arranged in the water-absorbing layer 4, between the permeable layer 3 and the water-absorbing layer 4, or between the water-absorbing layer 4 and the waterproof layer 5, wherein the position of the filler can specifically refer to the actual requirements, the material of the filler can be an anti-microbial material, and can also be active carbon, porous ceramisites and the like, specifically which is determined according to the actual requirements in order to implement the anti-microbial and deodorizing effect.

Furthermore, the filler can also be a perfumed material in order to cover the smell of the vegetable juice fallen on the bib.

In the embodiment, the materials of the permeable layer 3, the water-absorbing layer 4 and the waterproof layer 5 can be a disposable material, so, after the baby use the bib, the bib can be directly thrown away, which does not need to be repeatedly cleaned, does not cause secondary contamination and reduces the workloads of the parents.

The material of the water-absorbing layer 4 can be fluff pulp, high molecular water-absorbing resin, dust-free paper, a water-absorbing material such as diatom ooze, or other materials with the water-absorbing capacity, wherein the material of the water-absorbing layer 4 is preferably the high molecular water-absorbing resin and the fluff pulp, and the high molecular water-absorbing resin, the fluff pulp and the dust-free paper have high water-absorbing capacity and excellent water retention capacity.

The material of the permeable layer 3 can be pure cotton fabric, non-woven fabric or other materials with permeability, wherein the pure cotton fabric and the non-woven fabric do not hurt the skin of baby if they are used for a long time.

The material of the waterproof layer 5 can be a PE film (which is a special polyethylene plastic thin film), and can also be other materials with waterproofness.

In another preferable scheme of the embodiment, the edges of the waterproof layer 5, the water-absorbing layer 4 and the permeable layer 3 are fixedly connected in a pressing manner, that is, an edge pressing design is utilized in order to prevent internal materials from leaking out. Certainly, they can also be fixedly connected in a sewing manner.

In the embodiment, a sticking layer is arranged on the inner side of the sticky tongue 2 so that the sticky tongue 2 can be stuck on the inner side of the front collar; in order to ensure the stickiness of the sticking layer, a second anti-sticking layer covering the sticking layer is also arranged; and the sticky bib can be used as long as the first anti-sticking layer and the second anti-sticking layer are torn off.

Wherein the first anti-sticking layer 7 and the second anti-sticking layer can be provided with an integrated structure, and can also be provided with a separate structure, specifically which can be determined according to the actual requirements.

It should be noted that the material of the first anti-sticking layer 7 and the material the second anti-sticking layer can be release paper, and can also be other materials with the anti-sticking performance.

In some embodiments, the shape of the upper edge of the sticky bib main body 1 is consistent with the shape of the upper edge of the front collar, and can be arc; and the shapes of the other edges of the sticky bib main body 1 can be straight line, and can also be arc or other shapes, specifically which can be determined according to the actual requirements.

It should be understood that same or similar parts of the above embodiments can refer to each other, and contents, which are not described in detail in some embodiments, can refer to the same or similar contents in other embodiments.

Although the embodiments of the present application have been illustrated and described, it should be understood that the above embodiments are exemplary and should not be construed as limitations to the present application. Those of ordinary skill in the art can make changes, modifications, replacements and variations to the above embodiments without departing from the scope of the present application.

What is claimed is:

1. A disposable sticky bib comprising:
a sticky bib main body (1); and
a sticky tongue (2);
wherein the sticky bib main body (1) comprises:
a waterproof layer (5);
a water-absorbing layer (4); and
a permeable layer (3);
wherein the water-absorbing layer (4) is arranged between the permeable layer (3) and the waterproof layer (5);
a sticking layer (6); and
a first anti-sticking layer (7) capable of covering the sticking layer (6) are arranged on an inner side face of the waterproof layer (5); and
wherein the shape of the upper edge of the sticky bib main body (1) is consistent with the shape of the upper edge of a front collar, and the sticky tongue (2) may be bent and stuck on the inner side of the front collar.

2. The disposable sticky bib according to claim 1, characterized in that an anti-microbial and deodorizing filler is arranged in the water-absorbing layer (4), between the permeable layer (3) and the water-absorbing layer (4), or between the water-absorbing layer (4) and the waterproof layer (5).

3. The disposable sticky bib according to claim 1, characterized in that the material of the water-absorbing layer (4) is fluff pulp, high molecular water-absorbing resin or dust-free paper.

4. The disposable sticky bib according to claim 1, characterized in that the material of the permeable layer (3) is pure cotton fabric or non-woven fabric.

5. The disposable sticky bib according to claim 1, characterized in that the material of the waterproof layer (5) is a PE film.

6. The disposable sticky bib according to claim 1, characterized in that the edges of the permeable layer (3), the water-absorbing layer (4) and the waterproof layer (5) are fixed in a pressing manner.

7. The disposable sticky bib according to claim 1, characterized in that a sticking layer and a second anti-sticking layer are arranged on the inner side of the sticky tongue (2), the sticking layer is used for being stuck on the inner side of the front collar, and the second anti-sticking layer covers the sticking layer.

8. The disposable sticky bib according to claim 1, characterized in that the material of the sticking layer (6) is glue.

9. The disposable sticky bib according to claim 7, characterized in that the material of the first anti-sticking layer (7) and the material of the second anti-sticking layer are release paper.

10. The disposable sticky bib according to claim 1, characterized in that the edges of the permeable layer (3), the water-absorbing layer (4) and the waterproof layer (5) are fixed in a sewing manner.
